(19) United States
(12) Patent Application Publication
(10) Pub. No.: US 2015/0347469 A1
(43) Pub. Date: Dec. 3, 2015

(54) METHOD OF MANAGING DATA IN ARCHIVE SYSTEM BASED ON OPTICAL DISK

(71) Applicant: HITACHI-LG DATA STORAGE KOREA, INC., Seoul (KR)

(72) Inventor: Jong-Shik BAEK, Seoul (KR)

(73) Assignee: HITACHI-LG DATA STORAGE KOREA, INC., Seoul (KR)

(21) Appl. No.: 14/727,137

(22) Filed: Jun. 1, 2015

(30) Foreign Application Priority Data
Jun. 2, 2014 (KR) 10-2014-0066978

(51) Int. Cl. G06F 17/30; G11B 7/005; B65G 1/04; G11B 17/22

(52) U.S. Cl. CPC G06F 17/30289; G11B 17/225; G11B 7/005; B65G 1/04

(57) ABSTRACT

Disclosed herein is a method of managing data in an optical disk-based archive system. In an embodiment, when data is written in an optical disk, the metadata of the optical disk may be generated and stored. When a cartridge unit is drawn from an archive system and moved to a second archive system, the metadata of all the optical disks kept in the cartridge unit may be sent to another archive system through a medium. The metadata may be sent to another archive system over, a network, or the metadata may be copied to external memory and sent to another archive system. Furthermore, when a new cartridge unit is mounted on an archive system, a compression file may be received over a network or through external memory, and the metadata of all the optical disks kept in the new cartridge unit may be restored by decompressing the compression file.

### CROSS-REFERENCE TO RELATED APPLICATION

Pursuant to 35 U.S.C. §119(a), this application claims the benefit of earlier filing date and right of priority to Korean Patent Application No. 10-2014-0066978, filed on Jun. 2, 2014, the contents of which are incorporated by reference herein in their entirety.

### BACKGROUND OF THE INVENTION

1. Field of the Invention

The present invention relates to a method of managing data in an optical disk-based archive system and, more particularly, to a method of obtaining the metadata of a disk included in a cartridge unit rapidly and efficiently when the cartridge unit of an archive library system is moved to another system.

2. Discussion of the Related Art

With the development of image signal processing and data transfer technologies and large-sized display devices, viewers have become able to watch high-quality content, and there is an increasing need to store a large amount of content.

A cloud service in which data is uploaded on to a server in a remote place and the data can be used at any place where a network is available has recently been activated. A storage unit capacity provided to a person through such a cloud service is increased.

As described above, there is an increasing demand for a high-capacity server for storing and managing a large amount of data in portal sites providing cloud services, broadcasting stations providing a large amount of content, and libraries, public offices, and banks in which a large number of documents need to be archived and stored. In line with such necessities, archive systems capable of stably storing and rapidly searching for a large amount of data with at low cost are being released.

An archive system is a kind of database for converting collections or data into digital information, storing the digital information, and maintaining and managing relations between data, and is a system that enables permanent recording, preservation, and use by digitalizing information that may be deteriorated or scattered over time. The archive system does not simply accumulate information, but systemizes and accumulates information so that the information can be efficiently used in various ways.

An archive system using tapes as media has been chiefly used so far. The tape-based archive system is excellent in data stability, but has problems in that it has low search speed and occupies a large space. Furthermore, an archive system based on hard disks has emerged. The hard disk-based archive system is excellent in rapid search, but is problematic in that it has low data stability.

An archive system using optical disks as storage unit media has recently emerged. The optical disk-based archive system is advantageous in that it can rapidly perform search compared to the tape-based archive system, can stably store data compared to the hard disk-based archive system, and can reduce an occupied space compared to the tape- or hard disk-based archive system.

The optical disk-based archive system includes a cartridge unit for keeping a plurality of optical disks, a separated optical disk drive for writing data in an optical disk or reading data from an optical disk, and a separated picker robot, that is, a transfer device for moving an optical disk between the cartridge unit and the optical disk drive. Accordingly, the picker robot horizontally moves an optical disk pulled out from the cartridge unit, loads the optical disk onto the optical disk drive, unloads the optical disk on which data write/read have been performed in the optical disk drive from the optical disk drive, horizontally moves the unloaded optical disk, and inserts the optical disk into the cartridge unit.

Two cartridge units may be mounted on the optical disk-based archive system. Each of the cartridge units may keep 250 optical disks, for example. In a single archive system, the cartridge unit that keeps the optical disks in which data has been written has mobility in which the cartridge unit can be separated from the corresponding archive system and mounted on another archive system. That is, a large amount of data written in the optical disks of a cartridge unit can be easily moved to another system by separating only the cartridge in which the optical disks are kept from an archive system and mounting the cartridge unit on another system.

However, an archive system on which a cartridge unit has been newly mounted has to check that what data has been written in an optical disk kept in the newly mounted cartridge unit by repeating an operation for sequentially moving each of the optical disks of the cartridge unit from the cartridge unit to the optical disk drive, reading the optical disk, and moving the optical disk to the cartridge unit. Such a process is problematic in that lots of resources are used for the archive system and a lot of time is taken.

### SUMMARY OF THE INVENTION

An object of the present invention is to provide a method of efficiently moving the metadata of an optical disk kept in a cartridge unit when moving the cartridge unit in an optical disk-based archive system.

Another object of the present invention is to provide a method of obtaining the metadata of an optical disk kept in a newly mounted cartridge unit using small resources in an optical disk-based archive system.

In accordance with an embodiment of the present invention, there is provided a method of managing data in an optical disk-based archive system for transferring an optical disk between a cartridge unit configured to keep a plurality of optical disks and an optical disk drive and writing data in an optical disk and read data written in an optical disk through the optical disk drive. The method includes generating the metadata of an optical disk when data is written in the optical disk, storing the generated metadata, and sending the metadata of all the optical disks kept in the cartridge unit to a second archive system through a medium when the cartridge unit is drawn from the archive system and moved to the second archive system.

In an embodiment, sending the metadata of all the optical disks may include sending the metadata to the second archive system over a network.

In an embodiment, sending the metadata of all the optical disks may include copying the metadata to external memory and sending the metadata to the second archive system through the external memory.

In an embodiment, storing the generated metadata may include writing the metadata in the directory of the cartridge unit in which the corresponding optical disk is kept.

In an embodiment, storing the generated metadata may include writing the generated metadata in a file form of an XML format.

In an embodiment, sending the metadata of all the optical disks may include converting the metadata of all the optical disks kept in the cartridge unit into a compression file and sending the compression file.

In an embodiment, when a new cartridge unit is mounted on the archive system, a compression file may be received over a network or through external memory, and the metadata of all the optical disks kept in the new cartridge unit may be restored by decompressing the compression file.

In accordance with another embodiment of the present invention, there is provided an optical disk-based archive system, including a drive bay unit configured to include an optical disk drive for writing data in an optical disk or read data written in an optical disk, a cartridge unit configured to keep a plurality of optical disks, a picker robot configured to move an optical disk, a robot transfer unit configured to move the picker robot between the drive bay unit and the cartridge unit, a storage unit configured to temporarily store data, a network unit configured to provide an interface in order to exchange data with a host, and a control unit configured to transfer an optical disk kept in the cartridge unit to the optical disk drive through the picker robot and transfer the optical disk within the optical disk drive to the cartridge unit through the picker robot in order to write data in the optical disk or read data from the optical disk in response to a command received through the network unit. When writing data in an optical disk, the control unit generates the metadata of the optical disk and stores the generated metadata in the storage unit. When the cartridge unit is drawn from the archive system and moved to a second archive system, the control unit converts the metadata of all the optical disks kept in the cartridge unit into a compression file and sends the compression file to the second archive system through a medium.

In an embodiment, the control unit may send the compression file to the second archive system by controlling the network unit.

In an embodiment, the archive system further includes an interface unit configured to include a connection terminal for sending and receiving data to and from an external memory and a controller for controlling a flow of data through the connection terminal. The control unit may copy the compression file to the external memory and send the compression file to the second archive system by controlling the interface unit.

In an embodiment, when a new cartridge unit is mounted on the archive system, the control unit may directly receive the compression file through the network unit or receive the compression file from the external memory through the interface unit and may restore the metadata of all the optical disks kept in the new cartridge unit by decompressing the compression file.

### BRIEF DESCRIPTION OF THE DRAWINGS

FIG. 1 illustrates an optical disk-based archive system;

FIG. 2 illustrates a mechanism for transferring an optical disk in the optical disk-based archive system;

FIG. 3 illustrating the configuration of the function blocks of the optical disk-based archive system to which an embodiment of the present invention is applied;

FIG. 4 illustrates a process of sending the metadata of optical disks, included in a cartridge unit, to an archive system that will move the cartridge unit over a network in accordance with an embodiment of the present invention; and

FIG. 5 illustrates a process of copying the metadata of optical disks, included in a cartridge unit, to an archive system to which the cartridge unit will be moved through USB memory in accordance with another embodiment of the present invention.

### DETAILED DESCRIPTION OF THE EMBODIMENTS

Hereinafter, a method of managing data in an optical disk-based archive system in accordance with embodiments of the present invention is described in detail with reference to the accompanying drawings.

In the optical disk-based archive system, a plurality of optical disks is kept in cartridge units separated left and right. A picker robot that moves between the left and right cartridge units picks up the optical disks from the cartridge unit, moves in the length direction of the cartridge unit in the state in which the optical disks have been fixed to a disk handling assembly, that is, the body of the picker robot, loads the optical disks on to an optical disk drive or unloads optical disks from the optical disk drive, moves in the state in which the optical disks have been fixed to the body of the picker robot, and inserts the optical disks into the cartridge unit. The optical disk drive writes data in the loaded optical disks or reads data from optical disks.

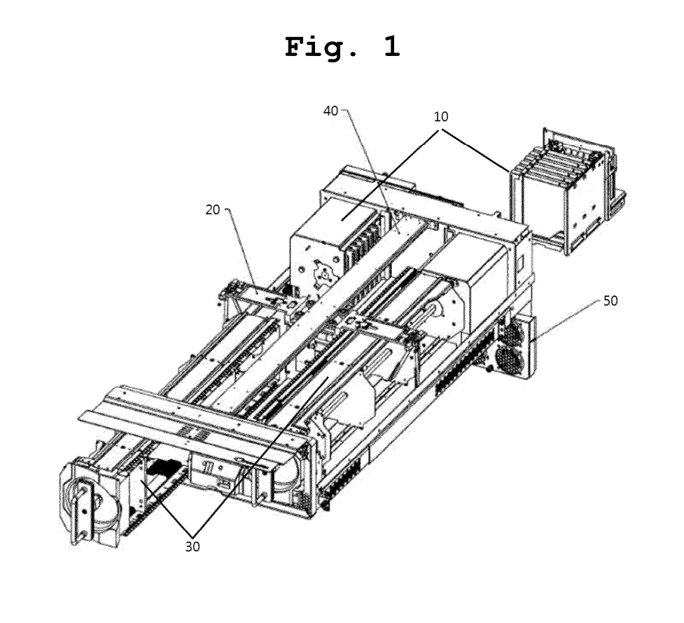

FIG. 1 illustrates an optical disk-based archive system.

The optical disk-based archive system 100 may be configured to include drive bay units 10 configured to have a plurality of optical disks drive (ODD) installed therein, a picker robot 20 configured to move an optical disk, cartridge units 30 each configured to keep a plurality of optical disks, a robot transfer unit 40 configured to drive and guide the picker robot 20 so that it may move between the drive bay units 10 and the cartridge units 30, and a fan module 50 configured to have a plurality of cooling fans for dissipating heat generated from the optical disk drive installed therein.

The drive bay units 10 and the cartridge units 30 may be symmetrically disposed left and right. The guide of the robot transfer unit 40 may be installed between the left and right drive bay units 10 and the left and right cartridge units 30, so the picker robot 20 may move between the left and right drive bay units 10 and cartridge units 30 in the length direction of the cartridge units 30.

For example, 6 optical disk drives may be installed in the drive bay unit 10. Accordingly, a maximum of 12 optical disks may be loaded onto the left and right drive bay units 10, and thus data write or data read operations can be performed at the same time.

For example, 250 optical disks may be kept in the cartridge unit 30. Accordingly, a maximum of 500 optical disks may be kept in the left and right cartridge units 30 installed on both sides of the picker robot 20. The cartridge unit 30 may be separated from the archive system. Furthermore, the back of the cartridge unit 30 has an open type, and thus the cartridge unit 30 is spaced apart from the back of a cartridge disk rack. Accordingly, there is a sufficient penetration space in which the kicker arm of the picker robot 20 may push the optical disks into the body of the picker robot 20.

The key rod of the cartridge unit that is used to fasten or release the cartridge unit to or from the system penetrates a disk center hole within the cartridge unit. When the cartridge unit is placed outside the archive system, the key rod is used to lock the optical disk to the cartridge unit and to carry the cartridge unit.

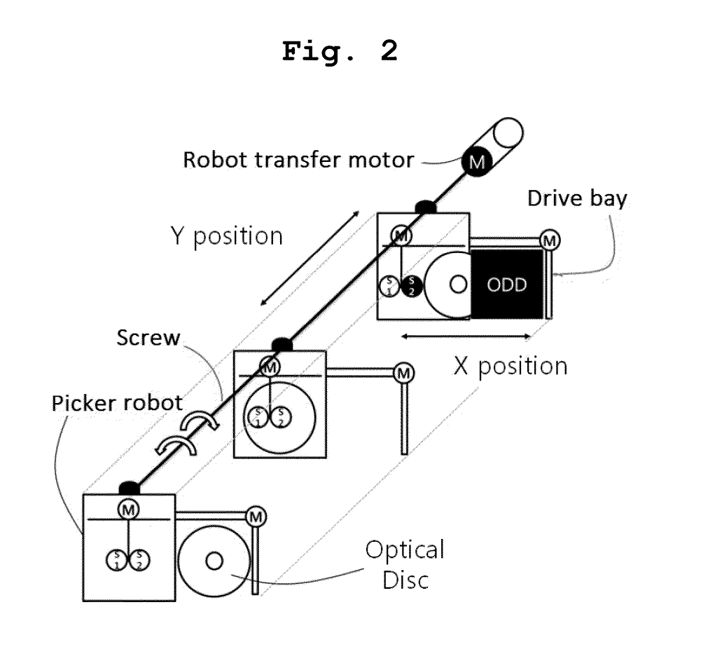

FIG. 2 illustrates a mechanism for transferring an optical disk in two directions in the optical disk-based archive system.

As illustrated in FIG. 2, the optical disk-based archive system 100 includes transfer in an X direction in which an optical disk is led in/drawn from (or loaded onto/unloaded from) the optical disk drive of the drive bay unit 10 or the cartridge unit 30 and transfer in a Y direction in which an optical disk is kept in the disk handling assembly, that is, the body of the picker robot 20, and transferred.

The transfer in the Y direction is for moving the picker robot 20 to a required location in order to lead or draw an optical disk, kept in the disk handling assembly of the picker robot 20, in or from a required optical disk drive within the drive bay unit 10 and a required slot within the cartridge unit 30. The transfer in the Y direction is performed when the picker robot 20 moves along a guide provided at the center between the left and right drive bay units 10 and between the left and right cartridge units 30.

The guide may be configured to include a robot transfer screw for driving the picker robot 20 back and forth and a robot transfer motor for rotating the robot transfer screw. The picker robot 20 may include a connection structure connected to the valley or mountains of the robot transfer screw and configured to transform the rotary motion of the robot transfer screw into a straight-line motion in the Y direction.

The transfer in the X direction is performed by an unloading mechanism within the optical disk drive of the drive bay unit 10, the rotary motion of the kicker arm of the picker robot 20, and the driving of an actuator included in the disk handling assembly. A device for moving an optical disk in the X direction is provided in the optical disk drive, the cartridge unit 30, and the disk handling assembly.

The picker robot 20 moves an optical disk within the cartridge unit 30 to the disk handling assembly, that is, the body, through the kicker arm and the actuator of the disk handling assembly. In this case, the picker robot 20 detects the location of the optical disk placed in the disk handling assembly and moves the optical disk in the X direction so that the optical disk is placed at the center of the body of the picker robot.

In order to read data from the optical disk placed in the cartridge unit 30 as described above, the archive system 100 commonly uses system resources. To this end, the archive system 100 needs to perform an operation for drawing the optical disk from the cartridge unit 30 (i.e., transfer in the X direction) and moving the optical disk to the drive bay unit 10 (i.e., transfer in the Y direction) and loading the optical disk onto the optical disk drive (i.e., transfer in the X direction) by controlling the picker robot 20 and the robot transfer unit 40.

In particular, when moving a cartridge unit in which a plurality of optical disks has been kept to another archive system, the archive system on which the cartridge unit has been newly mounted has to sequentially move the optical disks one by one, and the optical disk drive has to read the optical disks in order to check the metadata of the optical disks kept in the cartridge unit. Accordingly, many system resources are used, a lot of time is taken, and a response to an external data read or data write request is impossible while reading the metadata.

In an embodiment of the present invention, in the optical disk-based archive system, when a cartridge unit of a first system in which user data has been stored is drawn out and mounted on a second system, all the optical disks of the cartridge unit are not transferred to the optical disk drive and data is not read from the optical disks, but the first system temporarily stores the metadata of the optical disks kept in the cartridge unit and sends a plurality of metadata to the second system on which the cartridge unit is to be mounted through a medium when drawing the cartridge unit. For example, the plurality of metadata may be directly transmitted to the second system over a network or through USB memory.

When writing user data in an optical disk of the cartridge unit 30, the archive system 100 may generate the metadata of the corresponding optical disk in an XML format, for example, may previously store the generated metadata in a storage unit 80, may modify the metadata whenever the optical disk is updated, may compress the metadata of all the optical disks kept in the cartridge unit 30 into a single compression file, for example, a TAR file before drawing the cartridge unit 30 and moving it to another system, and may copy the TAR file to the system 100 on which the cartridge unit 30 has been newly mounted over a network or through external memory, such as USB memory.

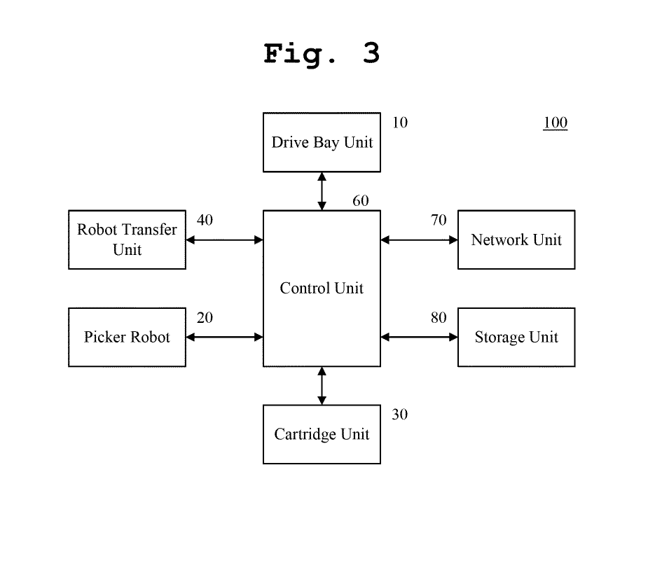

FIG. 3 illustrating the configuration of the function blocks of the optical disk-based archive system to which an embodiment of the present invention is applied.

The optical disk-based archive system 100 may be configured to include the drive bay unit 10 configured to involve data write and read, the picker robot 20 configured to implement the transfer of an optical disk in the X direction and the transfer of an optical disk in the Y direction, the cartridge unit 30 configured to keep a plurality of optical disks, the robot transfer unit 40 configured to drive the picker robot 20 so that it may move in the Y direction and to guide a motion of the picker robot 20, a control unit 60 configured to include a processor, memory, an operating system (OS), and customized program code and hardware and to command or control other hardware within the archive system, a network unit 70 connected to a server or host of a middleware form and configured to send and receive data and commands, and the storage unit 80, such as a hard disk or solid state drive (SSD) configured to temporarily store data read from an optical disk.

The optical disk-based archive system 100 may be configured to further include an interface unit, including connection terminals for sending and receiving data, such as memory slots, USBs, SCSI, E-SATA, and Firewire, and a controller for controlling a flow of data through the connection terminals. The optical disk-based archive system 100 may send data to an external device or USB memory connected thereto through the interface unit.

Cartridge flash may be used to store information about optical disks within the cartridge unit 30. The information may include a list listing the contents of the slots of the cartridge unit 30, the volume identifier of each of the optical disks, and a simple history of each optical disk including a rewriting number and error number of a rewritable disk.

An operator may connect an archive device (i.e., library) to a server of a middleware form through an application installed in an operator terminal, and the application may control the archive device. Library software for managing a device operation may be installed in the single board computer (SBC) of the archive device.

The control unit 60 connects to the middleware and the application by executing the library software, checks performance, such as the read and write of the optical disk drive included in the drive bay unit 10 in response to the command of an operator through the application, and writes or reads requested archive data or already archived data using the optical disk drive.

The library software executed by the control unit 60 receives commands and data by communicating with the server and/or the operator terminal through Ethernet via the network unit 70, and processes tasks within the archive system, for example, requests for the diagnosis and data access and storage of the archive system, such as the selection and movement of an optical disk, the loading of an optical disk on to the optical disk drive, and the driving of the optical disk drive through the picker robot 20 based on the received commands and data.

The control unit 60 generates the metadata of an optical disk in an XML format whenever it writes data in the optical disk of the cartridge unit 30 and stores the generated metadata in the storage unit 80. In this case, the control unit 60 may store a corresponding metadata file in the directory of the cartridge unit 30 in which the optical disk is kept, and may store the metadata file in association with the identifier of the optical disk or the location (or slot number) at which the optical disk is kept in the cartridge unit 30.

When a drawing command for the cartridge unit 30 is received from an operator, the control unit 60 may read the metadata files of all the optical disks kept in the cartridge unit 30 that has been requested from the storage unit 80, may compress all the metadata files into a single file, for example, a TAR file, may store the TAR file in the storage unit 80, and then may copy the TAR file over a network or through external memory. A system on which the drawn cartridge unit 30 will be mounted may restore the metadata of the optical disks by decompressing the TAR file.

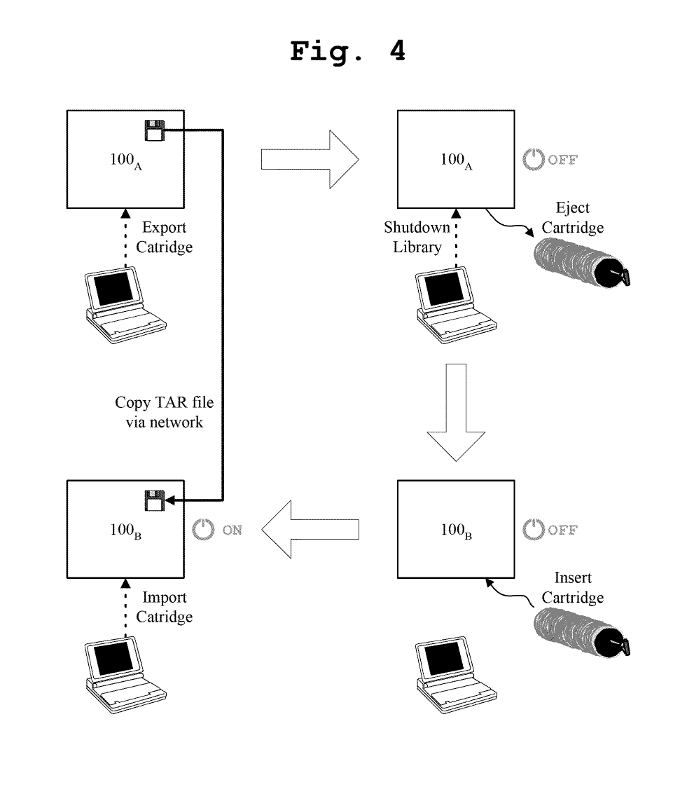

FIG. 4 illustrates a process of sending the metadata of optical disks, included in the cartridge unit, to an archive system that will move the cartridge unit over a network in accordance with an embodiment of the present invention.

When an operator requests to draw the cartridge unit 30 of a first archive system 100_{A} through an application installed in an operator terminal, the control unit 60 searches the storage unit 80 for the directory of the cartridge unit including the XML files of the metadata of optical disks kept in the requested cartridge unit 30, and compresses the XML files of the metadata recorded on the directory into a single compression file. For example, the control unit 60 may generate a TAR file by compressing the XML files.

Thereafter, the operator turns off the power source of the first archive system 100_{A} through the application and separates the cartridge unit 30 from the archive system. In this case, the operator may insert the key rod into the cartridge unit 30, and may fix the key rod through the center holes of the optical disks kept in the cartridge unit 30 so that the optical disks are not detached from the cartridge unit 30 while the cartridge unit 30 is moved.

Thereafter, the operator inserts the separated cartridge unit 30 into a second archive system 100_{B}. In this case, the operator may insert the cartridge unit 30 in the state in which the power source of the second archive system 100_{B} has been turned off.

The operator may turn on the power source of the second archive system 100_{B}, may connect the second archive system 100_{E} to the first archive system 100_{A} over a network, may receive the compression file stored in the storage unit 80 of the first archive system 100_{A}, may decompress the compression file, and may restore the metadata of all the optical disks kept in the newly mounted cartridge unit 30 by reading the XML files including the metadata of the optical disks.

For reference, since only flash memory is electrically connected to the archive system 100, the cartridge unit 30 may draw or insert the cartridge unit 30 without a big problem in the state in which the power source of the archive system 100 has not been turned off.

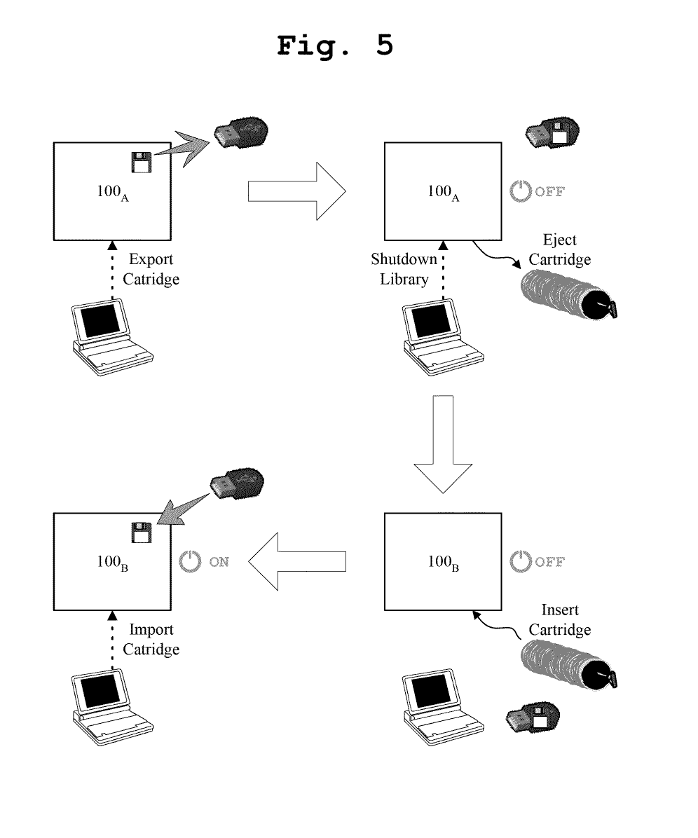

FIG. 5 illustrates a process of copying the metadata of optical disks, included in a cartridge unit, to an archive system to which the cartridge unit will be moved through USB memory in accordance with another embodiment of the present invention.

In FIG. 5, a compression file generated by compressing the XML files of metadata is copied to external memory, such as USB memory, the compression file is copied to an archive system on which the cartridge unit 30 has been newly mounted, and the metadata is released by decompressing the copied compression file. The embodiment of FIG. 5 is the same as the embodiment of FIG. 4 in which the compression file is transmitted over a network except a method of moving the compression file, and thus a detailed description thereof is omitted.

If metadata is to be moved to USB memory, the XML metadata files of all the optical disks may be copied or the directory of a cartridge unit including the XML metadata files may be moved to the USB memory without generating a compression file, such as a TAR file, if a storage capacity is sufficient.

Accordingly, when a cartridge unit is transferred to another archive system, the metadata of optical disks kept in the corresponding cartridge unit can be rapidly obtained.

As described above, the present invention can prevent the waste of the resources of an archive system consumed in order to access a large number of optical disks in a process of obtaining the metadata of the optical disks kept in a newly mounted cartridge unit.

The exemplary embodiments of the present invention have been disclosed for illustrative purposes, and those skilled in the art may improve, change, replace, or add various other embodiments within the technical spirit and scope of the present invention disclosed in the attached claims.

What is claimed is:

1. A method of managing data in an optical disk-based archive system for transferring an optical disk between a cartridge unit configured to keep a plurality of optical disks and an optical disk drive and writing data in an optical disk and read data written in an optical disk through the optical disk drive, the method comprising:
generating metadata of an optical disk when data is written in the optical disk and storing the generated metadata; and
sending metadata of all optical disks kept in the cartridge unit to a second archive system through a medium when the cartridge unit is drawn from the archive system and moved to the second archive system.

2. The method of claim 1, wherein sending the metadata of all the optical disks comprises sending the metadata to the second archive system over a network.

3. The method of claim 1, wherein sending the metadata of all the optical disks comprises:
copying the metadata to external memory, and
sending the metadata to the second archive system through the external memory.

4. The method of claim 1, wherein storing the generated metadata comprises writing the metadata in a directory of the cartridge unit in which the corresponding optical disk is kept.

5. The method of claim 1, wherein storing the generated metadata comprises writing the generated metadata in a file form of an XML format.

6. The method of claim 1, wherein sending the metadata of all the optical disks comprises:
converting the metadata of all the optical disks kept in the cartridge unit into a compression file, and
sending the compression file.

7. The method of claim 1, further comprising:
receiving a compression file over a network or through external memory when a new cartridge unit is mounted on the archive system, and
restoring metadata of all optical disks kept in the new cartridge unit by decompressing the compression file.

8. An optical disk-based archive system, comprising:
a drive bay unit configured to comprise an optical disk drive for writing data in an optical disk or read data written in an optical disk;
a cartridge unit configured to keep a plurality of optical disks;
a picker robot configured to move an optical disk;
a robot transfer unit configured to move the picker robot between the drive bay unit and the cartridge unit;
a storage unit configured to temporarily store data;
a network unit configured to provide an interface in order to exchange data with a host; and
a control unit configured to transfer an optical disk kept in the cartridge unit to the optical disk drive through the picker robot and transfer the optical disk within the optical disk drive to the cartridge unit through the picker robot in order to write data in the optical disk or read data from the optical disk in response to a command received through the network unit,
wherein when writing data in an optical disk, the control unit generates metadata of the optical disk and stores the generated metadata in the storage unit, and
when the cartridge unit is drawn from the archive system and moved to a second archive system, the control unit converts metadata of all optical disks kept in the cartridge unit into a compression file and sends the compression file to the second archive system through a medium.

9. The optical disk-based archive system of claim 8, wherein the control unit sends the compression file to the second archive system by controlling the network unit.

10. The optical disk-based archive system of claim 8, further comprising an interface unit configured to comprise a connection terminal for sending and receiving data to and from an external memory and a controller for controlling a flow of data through the connection terminal,
wherein the control unit copies the compression file to the external memory and sends the compression file to the second archive system by controlling the interface unit.

11. The optical disk-based archive system of claim 10, wherein when a new cartridge unit is mounted on the archive system, the control unit directly receives the compression file through the network unit or receives the compression file from the external memory through the interface unit and restores metadata of all optical disks kept in the new cartridge unit by decompressing the compression file.
